(19) United States
(12) Patent Application Publication
(10) Pub. No.: US 2005/0181841 A1
(43) Pub. Date: Aug. 18, 2005

(54) Audio system with acoustic shock control

(76) Inventor: Xinyu Dou, Buffalo Grove, IL (US)

Correspondence Address: MOTOROLA INC, 600 NORTH US HIGHWAY 45, ROOM AS437, LIBERTYVILLE, IL, 60048-5343, US

(21) Appl. No.: 10/777,695

(22) Filed: Feb. 12, 2004

(51) Int. Cl. H04B 1/38; H04M 1/00

(52) U.S. Cl. 455/575.1; 455/90.3

(57) ABSTRACT

A cellular telephone (100, 1300) comprises an earpiece speaker (234, 1312) and a loudspeaker (238, 1316) that share a common resonator (e.g., 1436). Sharing a common resonator allows the common resonator to be made large thereby improving bass response. Undesirable acoustic coupling through the common resonator is addressed by driving the earpiece speaker with a cancellation filtered version of the loudspeaker drive signal when the loudspeaker is driven.

### BACKGROUND OF THE INVENTION

1. Field of the Invention

The present invention relates in general to audio systems of handheld devices. More particularly, the present invention relates to audio systems for wireless communication devices.

2. Description of Related Art

Cellular telephones are a ubiquitous sight in today's societies. Presently there is an interest in enhancing the functionality and user experience in using portable electronic apparatus such as cellular telephones.

In the past simple tone alert alerts were used in wireless communication devices such as cellular telephones in order to alert user's to received wireless communications, e.g. telephone calls or text messages. Presently there is an interest in enhancing the audio capability of cellular telephones. To that end, cellular telephones equipped with miniature loudspeakers capable of outputting polyphonic sound have been introduced. Such cellular telephones have two speakers: a lower powered which is to be held adjacent to the user's ear and used for outputting audio during telephone conversations, and the miniature loudspeaker, which typically has a higher power rating.

According to speaker design principles, an empty space that serves as a resonator is provided in back or front of each speaker. The volume of the empty space is important in determining the frequency cutoff for the speaker. Increasing the volume lowers the low frequency cutoff thereby increasing the useful audio bandwidth of the speaker. The small size of cellular telephones constrains the volume that can be provided for the audio system, and thus comprises the performance at low frequencies. With the addition of miniature loudspeakers additional volume within the cellular telephone must be set aside for another resonator, placing further demands on space.

Another issue to be contended with in the design of cellular telephones equipped with miniature loudspeakers is that of ‘acoustic shock’. In the present context acoustic shock refers to the potential problem of the loudspeaker sounding while the cellular telephone is held adjacent to the user's ear. Safety considerations, dictate that in such a situation, the level of sound reaching the user's ear from the miniature loudspeaker should not exceed a prescribed safety limit. To address the acoustic shock issue, acoustic isolation in the form of mechanical separation or partitions between the resonator volumes of the earpiece speaker and the miniature loudspeaker have been provided in prior art cellular telephones.

### BRIEF DESCRIPTION OF THE FIGURES

The present invention will be described by way of exemplary embodiments, but not limitations, illustrated in the accompanying drawings in which like references denote similar elements, and in which:

FIG. 1 is a perspective view of a first clamshell type cellular telephone;

FIG. 2 is a fragmentary exploded view of an upper half of the cellular telephone shown in FIG. 1;

FIG. 3 is a circuit diagram in block form of the cellular telephone shown in FIGS. 1-2;

FIG. 4 a flow chart of a method of operating the cellular telephone shown in FIGS. 1-3;

FIG. 5 is a graph including electrical to acoustical transfer function plots for an earpiece speaker and a loudspeaker included in the cellular telephone shown in FIGS. 1-4, as measured using a first ear simulator, along with plots of residual frequency response after applying the method shown in FIG. 4;

FIG. 6 is a graph similar to that shown in FIG. 5 based on measurements with a second ear simulator;

FIG. 7 is a graph similar to that shown in FIG. 5 based on measurements with a third ear simulator;

FIG. 8 is a magnitude bode plot for a cancellation filter;

FIG. 9 is a phase bode plot for the cancellation filter shown in FIG. 8;

FIG. 10 is a 32 tap digital finite impulse response that approximates the cancellation filter shown in FIGS. 8-9;

FIG. 11 is a 64 tap digital finite impulse response that approximates the cancellation filter shown in FIGS. 8-9;

FIG. 12 is a 128 tap digital finite impulse response that approximates the cancellation filter shown in FIGS. 8-9;

FIG. 13 is a fragmentary cut-away plan view of a top half of a second clamshell cellular telephone;

FIG. 14 is a sectional elevation view of the clamshell cellular telephone shown in FIG. 13; and

FIG. 15 is a block diagram of an audio system of the cellular telephones shown in FIGS. 1-3, 14-15.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

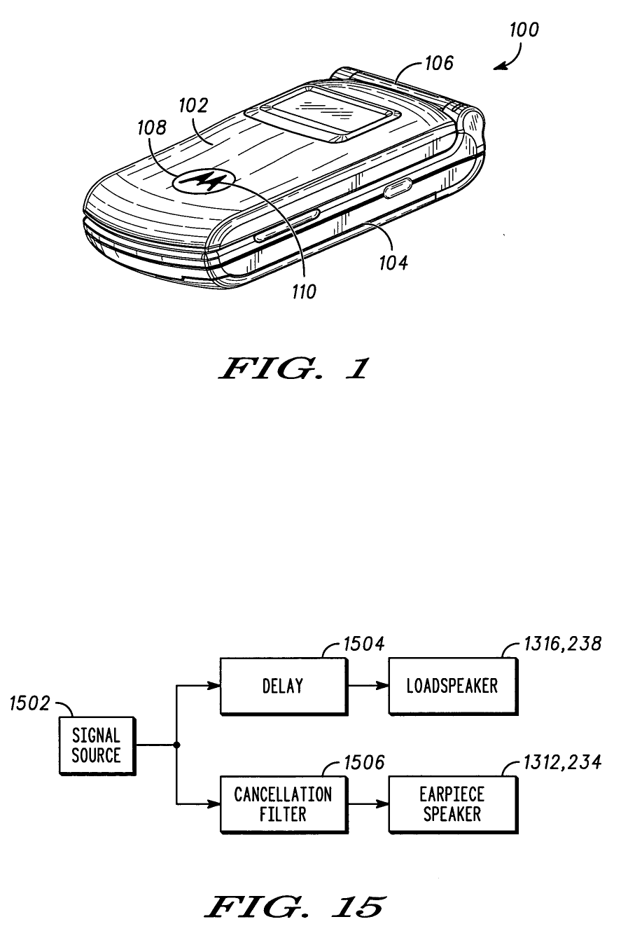

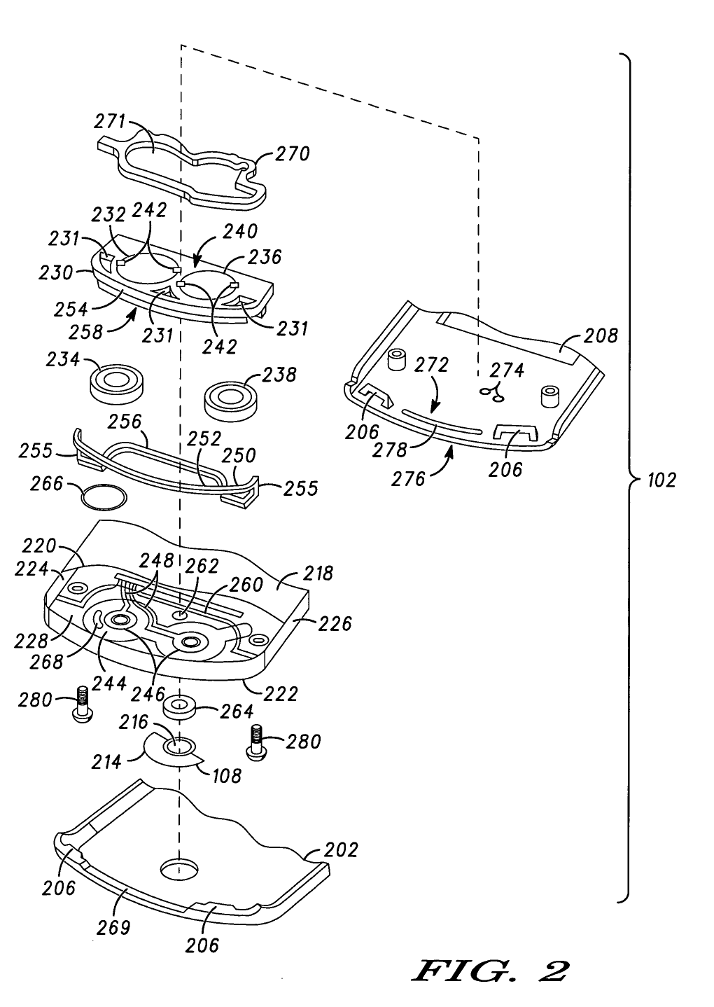

FIG. 1 is a perspective view of a clamshell type cellular telephone 100 according to a first embodiment of the invention. The cellular telephone 100 comprises an upper half 102, and a lower half 104 that are connected by a hinge 106. In use the upper half 102, and the lower half 104 are pivoted away from each other, revealing a keypad (not shown) built into the lower half 104, and a display (not shown) built into the upper half 102. The upper half 102 also encloses acoustic components including a miniature loudspeaker 234 (FIG. 2) and an earpiece speaker 238 (FIG. 2). An acoustic port cover 108 through which sound is coupled from the loudspeaker 238 to the outside is included in the upper half 102.

FIG. 2 is a fragmentary exploded view of the upper half 102 cellular telephone shown 100 in FIG. 1 showing various acoustic components. The upper half 102 includes an external plastic housing that includes an outer external housing part 202, that attaches to an inner external housing part 204. The inner 202 and outer 204 external housing parts are provided with interlocking tabs 206 that secure the external housing parts 202, 204 together. In the assembled cellular telephone 100, the outer external housing part 202 will face the outside when the upper 102 and lower 104 halves of the telephone 100 are brought together (as shown in FIG. 1).

The inner external housing part 204 is suitably provided with a cutout 208 that frames a display (not shown) that is supported in the upper half 102. The outer external housing part 202 is provided with a hole 210, into which the acoustic port cover 108 fits.

As shown in FIG. 2 the acoustic port cover 108 includes a cup shaped portion 212 that is attached to a semicircular flange 214. A first opening 110 (FIG. 1) that can be made in the shape of a logo is formed at the bottom (in the perspective of FIG. 2, top in the perspective of FIG. 1) of the cup shaped portion 212. A mesh 216 is disposed at the bottom of the cup shaped portion 212 over the first opening 110.

An inner housing 218 is located between the inner 202, and outer 204 external housing parts. The inner housing 218 comprises an upper (in the perspective of FIG. 2) inner housing part 220, and a lower inner housing part 222. Peripheral side wall portions 224, 226 of the upper 220, and lower 222 inner housing parts are fixed together e.g., by spot laser spot welding. The upper inner housing part 220 is shorter than the lower inner housing part 222 leaving an opening 228 in the inner housing 218 into which a congruently shaped plastic molded speaker holder 230 fits.

The speaker holder 230 comprises a first bore 232 into which a cylindrical earpiece speaker 234 is fitted, and a second bore 236 into which a cylindrical loudspeaker 238 is fitted. The earpiece speaker 234 and the loudspeaker 238 are fitted flush with a top surface 240 of the speaker holder 230. A plurality of stops 242 located on a top surface 240 of the speaker holder 230, at peripheries of the first 232, and second 236 bores, set the axial positioning of the speakers 234, 238.

A flexible printed circuit 244 is located in the opening 228 in the inner housing 218 below the speaker holder 230. The flexible printed circuit 244 comprises exposed contact pads 246, and traces 248 for coupling drive signals to the earpiece speaker 234, and the loudspeaker 238. The exposed contact pads 246 make contact with resilient contacts (not shown) attached to the bottom of the speakers 234, 238.

A three dimensionally contoured gasket 250 fits around the speaker holder 230. The contoured gasket 250 includes an upper portion 252 that is located along a top curved edge 254 of the speaker holder 230, and a lower portion 256 that runs along a bottom surface 258 of the speaker holder 230. The upper portion 252 and the lower portion 256, are connected by side portions 255. A bead of sealant 260 that aids in sealing is applied to the lower inner housing part 222 and aligns with the lower portion 256 of the contoured gasket 250. The contoured gasket 250 seals off a volume between the speaker holder 230 and the lower inner housing part 222 forming a first acoustic resonator. The back of the loudspeaker 238 is coupled to the first acoustic resonator. A hole 262 in the lower inner housing part 222 within an area bounded by the contoured gasket 250 serves as an acoustic port for the first acoustic resonator. A grommet 264 is located outside the inner housing 218, between the acoustic port cover 108 and the hole 262.

A circular gasket 266 is located between the earpiece speaker 234 and the flexible printed circuit 244. An arcuate opening 268 through the flexible printed circuit 244 is located in an area below the earpiece speaker 234 that is encompassed by the circular gasket 266. The arcuate opening 268 aligns with a congruently shaped opening (not shown) in the lower inner housing part 222. A portion of the flexible printed circuit 244 surrounding the arcuate opening 264 is sealed to the lower inner housing part 222 with a sealant (not shown). The sealant in conjunction with the circular gasket 266 serves to acoustically isolate the back of the earpiece speaker 234 from the first acoustic resonator. The back of the earpiece speaker 234 is coupled by the arcuate opening 268 to a space between the lower inner housing part 222, and the outer external housing part 202. An edge portion 269 of the outer external housing part 202 is recessed so as to leave a slot gap between the outer external housing part 202, and the inner external housing part 204 when the two 202, 204 are mated. The slot gap completes an acoustic coupling pathway between the back of the earpiece speaker 234, and the ambient environment.

A planar closed curved gasket 270 is disposed between a top surface 240 of the speaker holder 230, and the inner external housing part 204. The planar closed curve gasket 270, along with the top surface 240 of the speaker holder 230, and an inside surface 272 of the inner external housing part 204 define boundaries of a second acoustic resonator 271. Both the earpiece speaker 234 and the loudspeaker 238 face into, and are thereby acoustically coupled to the second acoustic resonator 271, and parasitically coupled to each other through the second acoustic resonator 271. A plurality of blind pockets 231 formed in the top surface 240 of the speaker holder 230 serve to increase the volume of the second resonator 271. A plurality of openings 274 through the inner external housing part 204, serve to couple acoustic energy from the earpiece speaker 234 to the user's ear when the cellular telephone 100 is in use. In use an outside surface 276 of the inner external housing part 204 is held to the user's ear. Making the second resonator 271 common to both speakers 234, 238, allows a relatively large volume resonator to be provided for both speakers 234, 238. This has the advantage of lowering the effective lower cutoff frequencies of the speakers 234, 238, which are partially determined by the volume of the acoustic resonators to which they are coupled, and thereby broadening the frequency responses of the speakers 234, 238. Typically, in the context, of cellular telephone design, coupling the earpiece speaker 234 and the loudspeaker 238 (e.g., via the second resonator 271) leads to the drawback that users of the cellular telephone 100 could be subjected to loud audio, if the cellular telephone 100 is held to a user's ear while the loudspeaker 238 is being driven. However, as described below in more detail, by driving the earpiece speaker 234 with a cancellation filtered version of the loudspeaker 238 drive signal, the loudness of audio to which the user would be subjected when holding the openings 274 to his or her ear while the loudspeaker 238 is driven is reduced. Driving the earpiece speaker 234 with a cancellation filtered version of the loudspeaker 238 drive signal allows the common second resonator 271 volume to be utilized to advantage as described above, without incurring the problem of uncontrolled coupling of acoustic energy from the loudspeaker 238 to the user's ear.

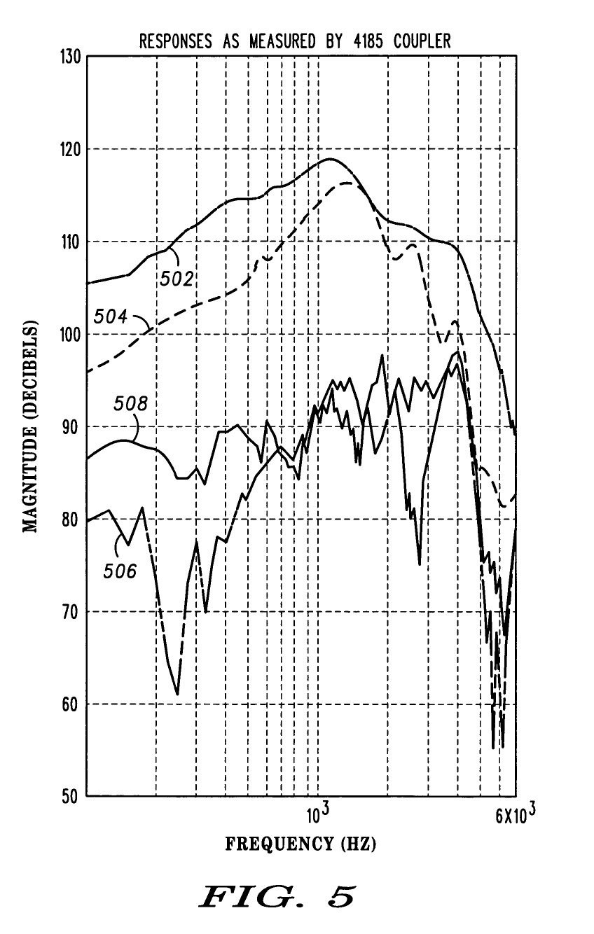

An arcuate slot 278 in the inner external housing part 204, outside the boundary of the second resonator 271 defined by the planar closed curved gasket 270, serves, in conjunction with the slot gap formed by recessed edge portion 269, to provide an acoustic wave energy leakage pathway from a space between the user's ear and the inner external housing part 204. Providing this leakage pathway, in conjunction with acoustically coupling the back of the earpiece speaker 234 to the ambient environment as described above, serves to reduce the dependence of the effective frequency response of the earpiece speaker 234, on the coupling condition between the user's ear and the inner external housing part 204. Various coupling conditions are explained below in reference to FIGS. 5-7.

A pair of screws 280 serve to mechanically couple the inner housing 218, the speaker holder 230, and the inner external housing part 204.

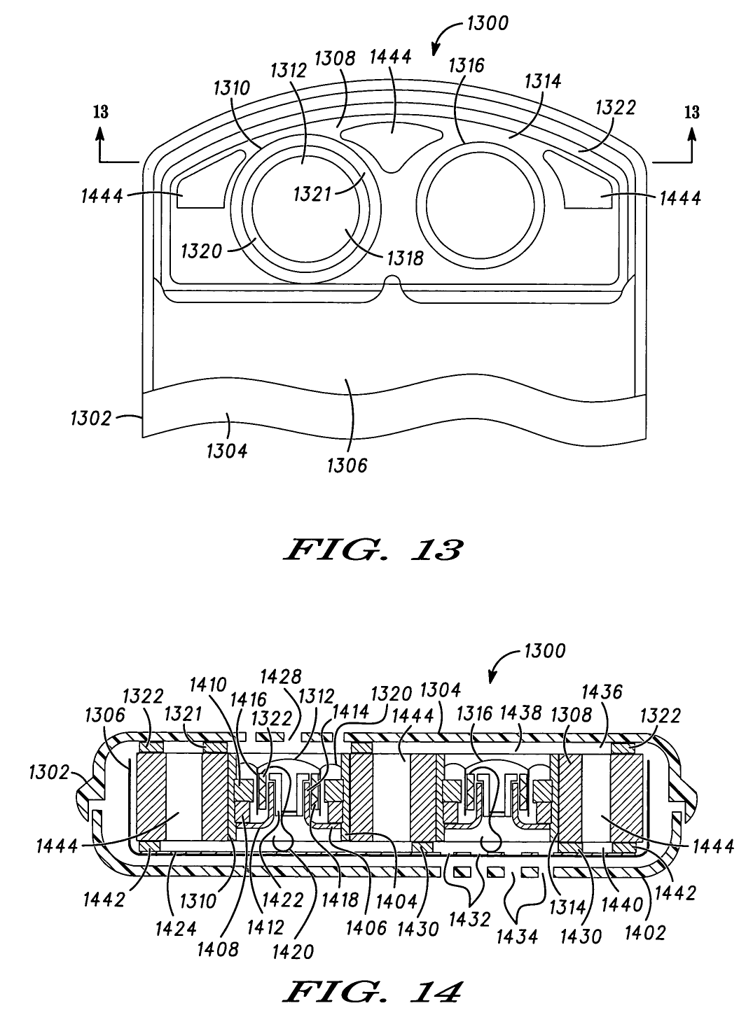

Although a particular device, i.e. cellular telephone 100, has been described above, it will be appreciated that the invention is of such a general character that it is applicable to cellular telephones that vary widely in the arrangement of acoustical components. FIGS. 1, 2 have been presented for the purpose of illustrating one particular implementation of the invention, however, the invention should not be construed as limited in applicability to cellular telephones having the particular arrangement of acoustic components shown in FIGS. 1,2. A substantially different acoustical arrangement, to which the invention is applicable is described below with reference to FIGS. 13-14.

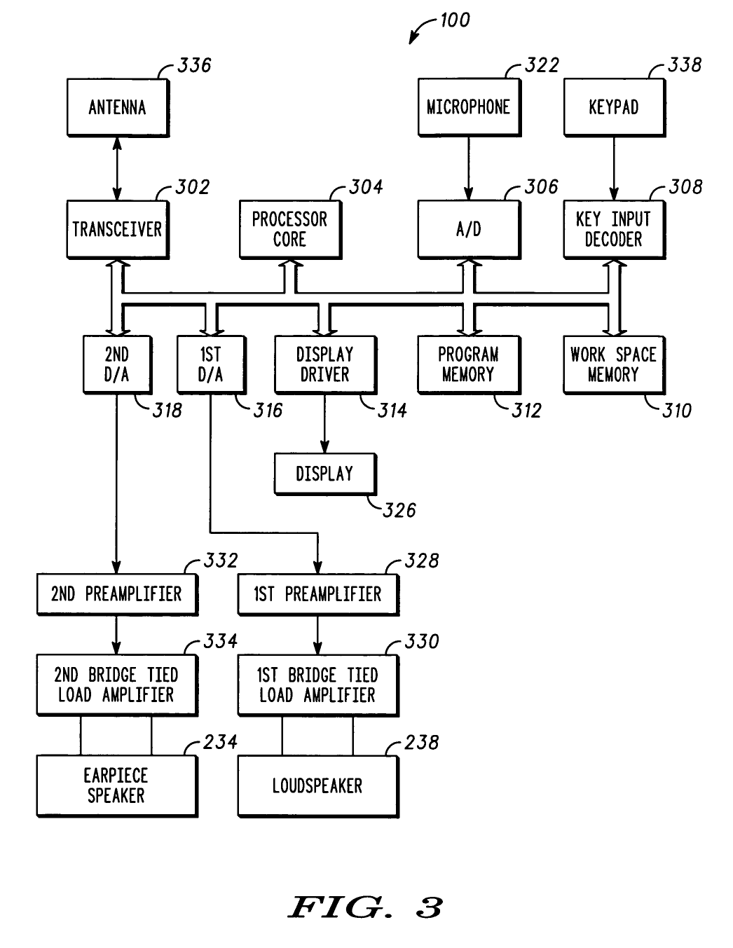

FIG. 3 is a circuit diagram in block form of the cellular telephone 100 shown in FIGS. 1-2. As shown in FIG. 3, the cellular telephone 100 comprises a transceiver module 302, a processor core 304, an analog to digital converter (A/D) 306, a key input decoder 308, a work space memory 310, a program memory 312, a display driver 314, a first digital to analog converter (D/A) 316, and a second D/A 318 coupled together through a digital signal bus 320.

The transceiver module 302 is coupled to an antenna 336. Carrier signals that are modulated with data, e.g., digitally encoded voice audio, pass between the antenna 336, and the transceiver 302.

A microphone 322 is coupled to the A/D 306. Audio, including spoken words, is input through the microphone 322 and converted to a stream of digital samples by the A/D 306.

A keypad 338 is coupled to the key input decoder 308. The key input decoder 308 serves to identify depressed keys, and provide information identifying each depressed key to the processor core 304. The display driver 314 is coupled to a display 326.

The first D/A 316 is coupled through a first preamplifier 328, and a first bridge tied load amplifier (BTL) 330 to the loudspeaker 238. Similarly, the second D/A 318 is coupled through a second preamplifier 332, and second BTL amplifier 334 to the earpiece speaker 234. The first 330 and second 334 BTL amplifiers provide bipolar drive signals for driving the loudspeaker 238, and earpiece speaker 234. The first D/A 316 converts pulse code modulation (PCM) digital signal samples to analog drive signals that are amplified by the first preamplifier 328 and first BTL amplifier 330 and drive the loudspeaker 238. The second D/A 312 converts PCM digital signal samples to analog signals that are amplified by the second preamplifier 332, and the second BTL amplifier 334 and drive the speaker 332.

One or more programs for processing data structures that include digitally encoded signals for driving the loudspeaker 238, and earpiece speaker 234 are stored in the program memory 312, and executed by the processor core 304. In operation, when the loudspeaker 238 is to be driven (e.g., to alert a user to a received call), a signal with which the loudspeaker 238 is to be driven is delayed before being applied to the loudspeaker. Concurrently the same loudspeaker drive signal is processed by a cancellation filter which is designed to modify the drive signal for the loudspeaker 238 to obtain a filtered drive signal for driving the earpiece speaker 234. The filtered drive signal causes the earpiece speaker 234 to generate an acoustic wave that destructively interferes with an acoustic wave generated by the loudspeaker in response to the loudspeaker drive signal. The destructive interference reduces the level of sound from the loudspeaker 238 that reaches sensitive parts of the user's ear. Delaying the drive signal, prior to applying the drive signal to the loudspeaker 238, provides time for the drive signal to be processed by the cancellation filter, so that drive signal and filtered drive signal are applied synchronously. Because, the earpiece speaker 234 is located proximate the user's ear, by driving the earpiece speaker with the filtered drive signal it is, in some cases, possible to cancel the acoustic power emitted by the loudspeaker 238 into the user's ear using a relatively low powered filtered drive signal. The cancellation effect is fortunately, focused such that audio emitted by the earpiece speaker in response to the filtered drive signal, does not, in general, mute the audio emitted by the loudspeaker 238 in directions, other than towards the user's ear. The delay and the cancellation filter are suitably implemented as program code that is executed by the processor core 304.

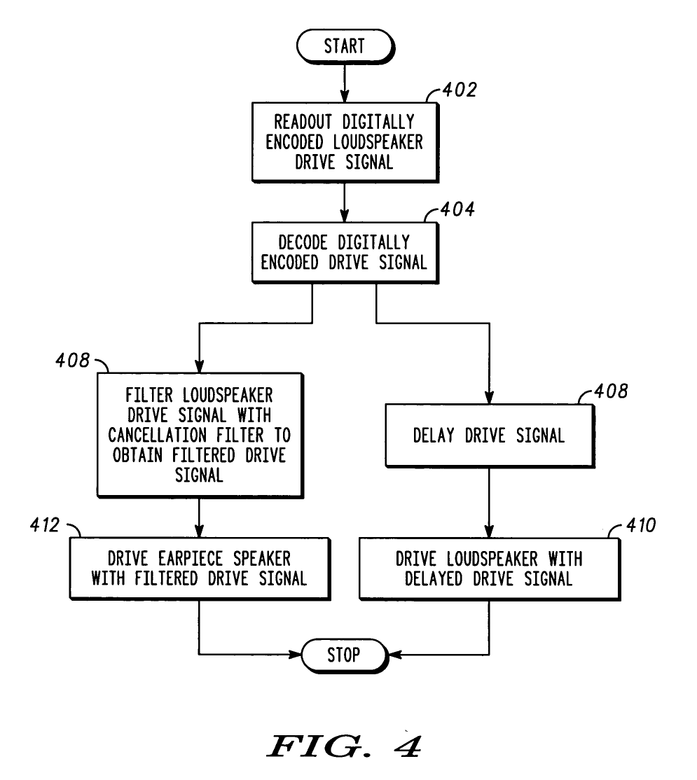

A program for processing data structures that include drive signals for the loudspeaker 238 is also described below with reference to FIG. 4. PCM digital signal samples that result from such processing are applied to the first D/A 316 in order to drive the loudspeaker 238, and are applied to the second D/A 318 in order to drive the earpiece speaker 234. Data structures that include digitally encoded drive signals for the loudspeaker 238, and the earpiece speaker 234 are optionally preprogrammed into the program memory 312, or received through the transceiver 302 and stored in the workspace memory 310. The drive signals for the loudspeaker 238, can for example, comprise, polyphonic melodies. Data structures including drive signals for the loudspeaker 238 are sometimes referred to as ‘ring tones’.

The program memory 312 is also used to store programs that control other aspects of the operation of the cellular telephone 100. The program memory 312 is a form of computer readable medium.

According to an alternative embodiment of the invention, the cellular telephone 100 comprises a digital signal processing (DSP) accelerator module that is well adapted for performing signal filtering operations such as multiply and accumulate operations. In such an alternative embodiment, it would be advantageous to use the DSP accelerator module to handle DSP operations such as filtering the loudspeaker drive signal.

FIG. 4 a flow chart of a method of operating the cellular telephone 100 shown in FIGS. 1-3 according to the first embodiment of the invention. A program embodying the method shown in FIG. 4 is suitably stored in the program memory 312, and executed by the processor core 304. However, it is noted, that the method shown in FIG. 4 can be carried out on a wide range of hardware other than that illustrated in FIG. 3. Examples of alternative hardware for implementing the method shown in FIG. 4 include dedicated digital or analog filter circuits for cancellation filtering the loudspeaker 238 drive signal.

Referring to FIG. 4 in step 402, a data structure that includes a digitally encoded loudspeaker drive signal is read out. In the context of the cellular telephone 100, as shown in FIG. 3, the data structure including the digitally encoded loudspeaker drive signal is suitably stored in the program memory 312, or the work space memory 310. A portion of the work space memory 310 optionally comprises a non-volatile memory, such as a flash memory, in which downloaded ring tones are stored. The data structure including the digitally encoded loudspeaker drive signal can for example comprise a compressed audio format file such as Motion Picture Expert Group (MPEG) Layer 3 file (commonly known as MP3), an uncompressed audio format file such a Waveform file (WAV), or a file format that encodes musical notes such as a Musical Instrument Digital Interface (MIDI) file.

In step 404 the data structure read out in step 404 is decoded to extract a digital (e.g., Pulse Code Modulation, PCM) representation of the drive signal. Step 404 uses a source decoder appropriate to the type of the data structure.

In step 406 the drive signal is filtered with a cancellation filter, in order to obtain a filtered version of the drive signal that is to be used for driving the earpiece speaker 234, while the loudspeaker 238 is driven with the unfiltered drive signal. The purpose of driving the earpiece speaker 234 with the filtered drive signal, is to reduce, by, at least, partial cancellation, the level of sound originating from the loudspeaker that is coupled into a user's ear. This is particularly useful in the case that the inner external housing part 204 (including openings 274) of the cellular telephone 100 is being held to the user's ear, when the loudspeaker 238 is unexpectedly activated. The design of the cancellation filter is described in more detail below with reference to FIGS. 5-12. The drive signal is readily filtered while it is still in digital form.

In step 408 the drive signal is delayed. The drive signal is delayed prior to being applied to the loudspeaker 238 in order to allow time for the drive signal to be filtered. According to certain embodiments of the invention, Finite Impulse Response (FIR) filters having 2N+1 taps are used to obtain a kth output sample by operating on 2N+1 input signal samples at a time, including N or N+1 samples preceding a kth input signal sample, and N+1 or N samples succeeding the kth input signal sample. In this case it is appropriate to delay the loudspeaker drive signal by N or N+1 samples in order that the filtered drive signal will be synchronized with the unfiltered drive signal. Other types of FIR filtering, or Infinite Impulse Response (IIR) filtering that is alternatively used may not require delaying the loudspeaker drive signal.

In step 410 the delayed drive signal is used to drive the loudspeaker, 238, and in step 412 the filtered drive signal is used to drive the earpiece speaker 234.

According to an alternative embodiment of the invention, a filtered version of the loudspeaker drive signal to be used in driving the earpiece speaker 234, is stored along with the loudspeaker drive signal in the program memory 312, or the work space memory 310, and is simply readout and used to drive the earpiece speaker 234. Storing the filtered version of the loudspeaker drive signal would eliminate the need to perform filtering step 406 in the cellular telephone 100 in real time. However, as a practical matter, given the manner in which ringbones are created and distributed it is not expected that it would be practical to distribute appropriately filtered versions suitable for each type of cellular phone implementing the invention. It would be practical to perform filtering one time within the cellular telephone 100, and store the filtered signal for future use.

FIG. 5 is a graph including electrical to acoustical magnitude transfer function plots for the earpiece speaker 234 and the loudspeaker 238 included in the cellular telephone 100 shown in FIGS. 1-4, as measured using a first ear simulator, along with plots of residual frequency response after applying the method shown in FIG. 4 using two different filters. The first ear simulator is a type 4185 manufactured by Brüel & Kjær of Nærum, Denmark. The type 4185 ear simulator is designed to conform to the ITU-T P.57 Type 1 specification. The type 4185 ear simulator is designed to model an idealized sealed condition between a user's ear and a surface of a cellular telephone 100 overlying an earpiece speaker, e.g., the surface 276 of the inner external housing part, surrounding the openings 274. In FIG. 5, plot 502 represents the transfer function of the earpiece speaker 234, and plot 504 represents the transfer function of the loudspeaker 238. As reflected in the plot, the earpiece speaker 234, which is intended to couple acoustic energy to the user's ear, is more strongly coupled to the user's ear over a broad frequency range. Nonetheless, the loudspeaker 238, which is generally operated at higher power levels, is also coupled to the user's ear as measured using the ear simulator. The coupling of the loudspeaker 238 to the user's ear poses the problem that the user could be subjected to undesirably loud sounds from the loudspeaker 238 if the cellular telephone 100 were held up to the user's ear while the loudspeaker 238 were operated. The coupling of the loudspeaker 238 to the user's ear is in part due to the fact the two speakers share the second resonator 271 volume. Although sharing the second resonator 271 volume advantageously decreases the low frequency cutoff of the speakers 234, 238 it also increases the coupling of the loudspeaker 238 to the user's ear which is not desirable.

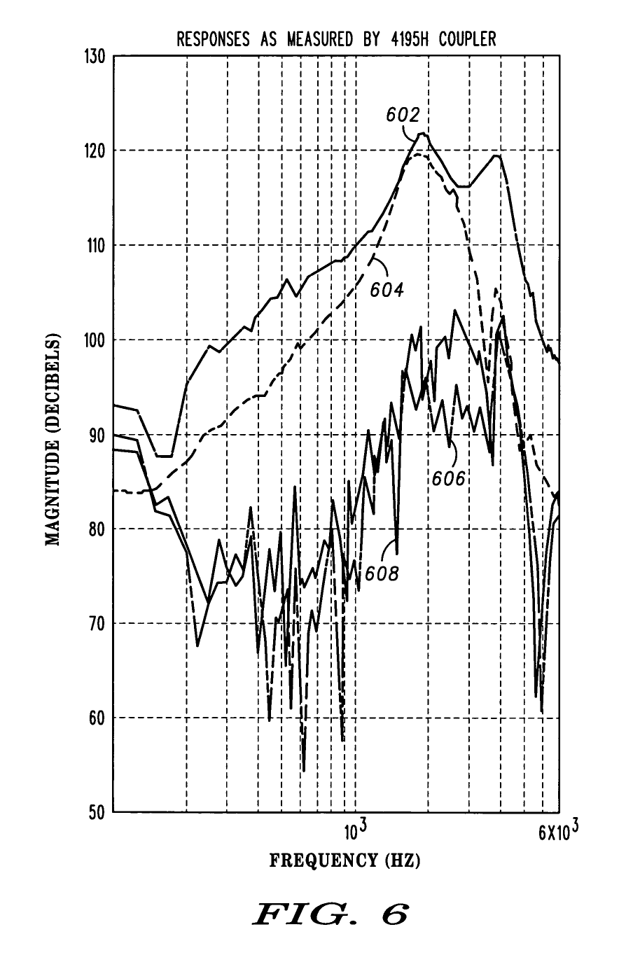

FIG. 6 is a graph similar to that shown in FIG. 5 based on measurements with a second ear simulator. The second ear simulator is a type 4195 manufactured by Brüel & Kjæar, equipped with a DB3598 high leakage outer ear simulator also manufactured by Brüel & Kjær. The second ear simulator equipped with the DB3598 outer ear simulator is designed to simulate a high leakage condition between the user's ear and the cellular phone 100, such as when the telephone 100 is held close to the user's ear but not pressed tightly to the ear. In FIG. 6, plot 602 is a transfer function of the earpiece speaker 234 measured with the type 4195 ear simulator equipped with the DB3598 outer ear simulator, and plot 604 is a transfer function of the loudspeaker measured with the type 4195 ear simulator equipped with the DB3598 outer ear simulator.

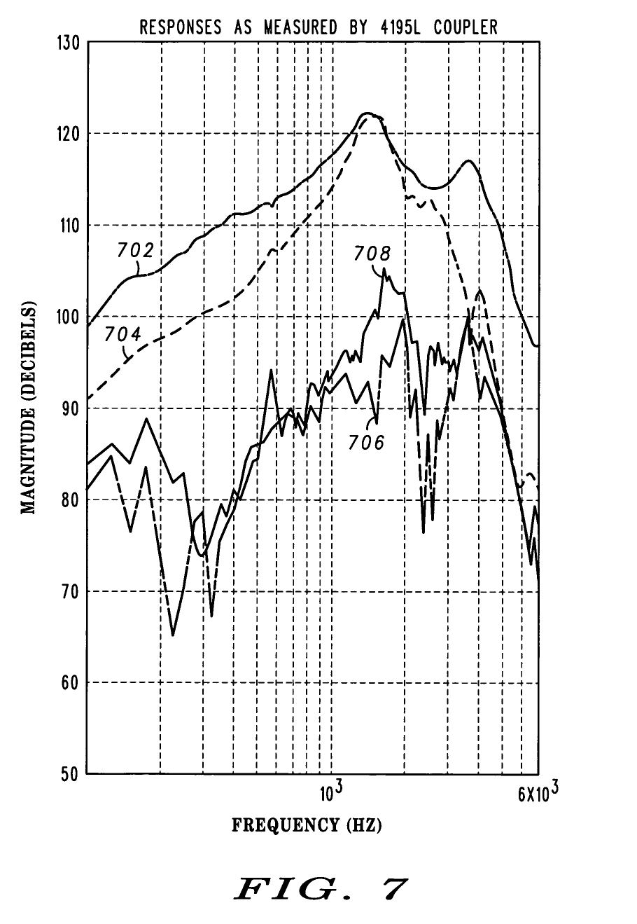

FIG. 7 is also a graph similar to that shown in FIG. 5 based on measurements with a third ear simulator. The third ear simulator is a type 4195 manufactured by Brüel & Kjær equipped with a DB3429 low leakage outer ear simulator, also manufactured by Brüel & Kjær. The latter configuration is designed to measure coupling to the ear under conditions intermediate to those shown in FIGS. 5 and 6. In FIG. 7 plot 702 is a transfer function of the earpiece speaker 234, and plot 704 is a transfer function of the loudspeaker 238.

As in FIG. 5 under sealed conditions, under high and low leakage conditions as shown in FIGS. 6,7, the loudspeaker transfer function is generally below the earpiece transfer function, but not insubstantial.

An issue to be contended with in designing a cancellation filter for use in the method shown in FIG. 4, is the fact that the transfer functions for the earpiece speaker 234 and loudspeaker 238 are different for different coupling conditions (e.g., sealed, low leakage, and high leakage). The design of the cancellation filter as will be described below aims to optimize the effectiveness of the cancellation filter operating under widely ranging coupling conditions.

Other plots appearing in FIGS. 5-7 are discussed further below.

For each coupling condition the overall transfer function which describes the cumulative transfer function of the loudspeaker 238 driven by the delayed drive signal, and the earpiece speaker driven by the filtered drive signal is expressed by:
TF=H_{c}(jω)*H_{E}^{k}(jω)+e^{-jwN}*H_{L}^{k}(jω) EQU. 1
where, H_{E}^{k}(jω) is the complex transfer function for the earpiece speaker, for a kth coupling condition;
where, H_{L}^{k}(jω) is the complex transfer function for the loudspeaker, for the kth coupling condition;
   e^{-jwN} represents a delay of N samples transformed into the frequency domain; and
   H_{c}(jω) is the complex transfer function of the cancellation filter which is to be determined.

The complex transfer functions, for the earpiece speaker 234, and loudspeaker 238 are obtained by measurement using the ear simulators described above, or by computer simulation. Although, only magnitude information is shown in FIGS. 5-7, complex quantities including magnitude and phase information are used in equation 1. Note that the complex transfer function of the cancellation filter does not have a superscript k indicating the coupling condition, because the cancellation filter will be pre-programmed and will typically remain fixed, independent of how the telephone 100 is held to the user's ear.

Using data for each particular coupling condition separately, the right hand side of equation 1 can be set equal to zero, and the resulting equation solved to determine the complex transfer function of the cancellation filter at each frequency point ω. The value of H_{c}(jω) determined in that manner would be optimized to cancel the acoustic power coupled to the user's ear under one particular coupling condition. However the value H_{c}(jω) thus determined would generally perform less well under other coupling conditions.

A preferred approach is to set up a system of equations, including one copy of equation 1, with the right hand side is set equal to zero, for each value of k (e.g., for the sealed, low leakage, and high leakage conditions). The system is written in matrix form as:

$$[ \begin{matrix}{H}_{E}^{1} \\ {H}_{E}^{2} \\ {H}_{E}^{3}\end{matrix} ] * [ {H}_{c} ( jω ) ] = [ \begin{matrix}{ⅇ}^{- jwN} * {H}_{L}^{1} ( jω ) \\ {ⅇ}^{- jwN} * {H}_{L}^{2} ( jω ) \\ {ⅇ}^{- jwN} * {H}_{L}^{3} ( jω )\end{matrix} ] \qquad EQU . 2$$

The system in equation two is overdetermined, however it can be solved using singular value decomposition (SVD) to determine a value of the cancellation filter complex transfer function H_{c}(jω) at each frequency point that is a good compromise value for minimizing the power coupled to the user's ear under different coupling conditions. Equation two is solved at each frequency point ω separately.

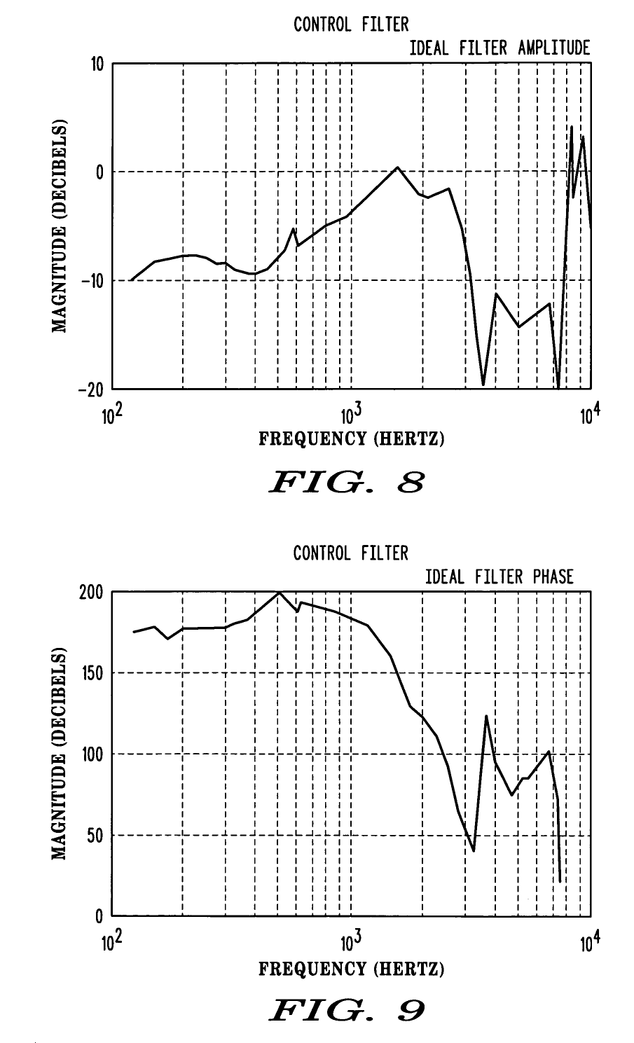

FIG. 8 is a magnitude bode plot for a cancellation filter according to the first embodiment of the invention, and FIG. 9 is a phase bode plot for the same cancellation filter. In FIG. 8, the abscissa is marked off in Hertz, and the ordinate marked off in decibels. In FIG. 9, the abscissa is marked off in Hertz, and ordinate is marked off in degrees. The characteristics of the cancellation filter shown in FIGS. 8-9 are obtained by solving equation two, at each frequency, using earpiece speaker, and loudspeaker complex transfer function data obtained under the three coupling conditions described above in the context of FIGS. 5-7.

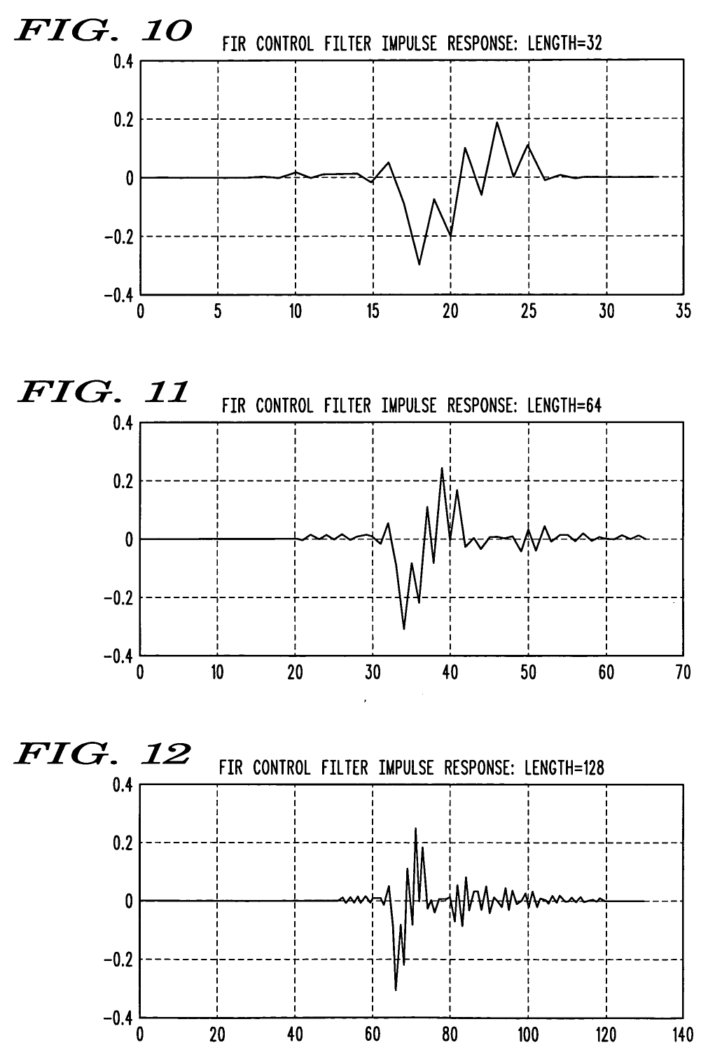

FIG. 10-12 show a 32, a 64 and a 128 tap digital FIR filter that approximate the cancellation filter characteristics shown in FIGS. 8-9. Known algorithms can be used for determining the tap coefficients for an FIR cancellation filter approximating the desired cancellation filter frequency response such as shown in FIGS. 8-9. Algorithms for determining FIR filter tap coefficients that approximate and arbitrary, complex (nonlinear phase) frequency response are described, for example, in L. J. Karam and J. H. McClellan, “A Combined Ascent-descent Algorithm for Complex Chebyshev FIR Filter Design,” 28th Annual Princeton Conference on Information Science and Systems, March 1994; L. J. Karam and J. H. McClellan, “A Multiple Exchange Remez Algorithm for Complex FIR Filter Design in the Chebyshev Sense,” IEEE International Symposium on Circuits and Systems, vol. 2, pages 517-520, May-June 1994; and L. J. Karam and J. H. McClellan, “Design of Optimal Digital FIR Filters with Arbitrary Magnitude and Phase Responses,” IEEE International Symposium on Circuits and Systems, vol. 2, pages 385-388, May 1996. One commercially available routine that is suitable for determining the tap coefficients of an FIR cancellation filter for use in performing the method shown in FIG. 4, is CREMEZ which is part of the signal processing toolkit of MATLAB a popular application for performing engineering calculations and programming. MATLAB is published by Mathworks of Natick, Mass.

In FIGS. 5-7 plots 506, 606, and 706 respectively show the residual magnitude frequency response of the combination of the loudspeaker 238, and the earpiece speaker 234 where the latter is driven through a cancellation filter the characteristics of which are determined by equation 2 and shown in FIGS. 8-9. Plots 508, 608, and 708 in FIGS. 5-7 show the residual magnitude frequency response of the combination of the loudspeaker 238, and the earpiece speaker 234 where the latter is driven through the 128 FIR tap shown in FIG. 12.

FIG. 13 is a fragmentary cut-away plan view of a top half of a clamshell cellular telephone 1300 according to a second embodiment of the invention, and FIG. 14 is a sectional elevation view of the clamshell cellular telephone 1300 shown in FIG. 13. The second cellular telephone 1300 comprises an outer housing 1302, including an upper outer housing part 1304, and a lower outer housing part 1402. The outer housing enclosed an inner housing 1306. A speaker holder 1308 is located within the inner housing 1306. The speaker holder 1308 includes a first bore 1310 that accommodates an earpiece speaker 1312, and a second bore 1314 that accommodates a loudspeaker 1316.

In the embodiment shown in FIGS. 13, 14, the construction of the earpiece speaker 1312, and loudspeaker 1316 is basically the same with the possible exception of some design parameters described below. With this understanding, a detailed description of the earpiece speaker 1312 is given below. The earpiece speaker 1312 comprises a cylindrical casing 1404. Stacked within the cylindrical casing 1404 are a lower magnetic pole piece, 1406, an annular magnet 1408, and upper annular magnetic pole piece 1410. The lower magnetic pole piece 1406 has a radially inward extending portion 1412, and an axially, upwardly extending portion 1414. The upwardly extending portion 1414 extends axial past the annular magnet 1408 to the position of the upper magnetic pole piece 1410. Magnetic flux emanating from the annular magnet 1408 passes through the lower magnetic pole piece 1406, and radially across a gap between the upwardly extending portion 1414, into the upper pole piece 1410.

A speaker diaphragm 1318 is supported toward the top of the speaker casing 1404 by a flexible peripheral ring 1320. A cylindrical skirt 1416 depends from the speaker diaphragm 1318. A voice coil 1418 encompasses the cylindrical skirt 1416. The voice coil 1418 is immersed in the magnetic flux crossing from the lower magnetic pole piece 1406 to the upper pole piece 1410.

A pair of electrical spring contacts 1420 (one of which is visible in FIG. 14) are supported by an electrical contact support 1422 that fits within the upwardly extending portion 1414 of the lower magnetic pole piece 1406. Leads of the voice coil 1418 are attached to the electrical spring contacts 1420. The electrical spring contacts 1420 engage contact areas on a flexible printed circuit 1424 that is positioned within the inner housing 1306 below the speaker holder 1308.

Although not apparent in FIG. 14, there are openings in the lower magnetic pole piece 1406, and the contact support 1422 to allow the back of the diaphragm 1320 to acoustically interact with the space (described below) below the earpiece speaker 1312.

As to the differences in design parameters between the two speakers, in the earpiece speaker the flexible peripheral ring 1320 supporting the diaphragm 1318 is suitably made of a more compliant material than the corresponding part in the loudspeaker 1316, in order to emphasize the response of the earpiece speaker 1312 at low frequencies.

A first circular gasket 1321 encircles the top of the earpiece speaker 1312 forming a seal between the speaker holder 1308, and the upper outer housing part 1304. Upper openings 1428 in the upper outer housing part 1304 within the outline of the first circular gasket 1321, serve to couple acoustic energy from the earpiece speaker 1312 to the user's ear. Similarly, a second circular gasket 1430 encircles the bottom of the loudspeaker 1316 forming a seal between the speaker holder 1308 and the inner housing 1306. Lower openings 1432 in the inner housing 1306, corresponding openings 1434 in the lower outer housing part 1402, and corresponding openings in the flexible printed circuit 1424, serve to couple acoustic energy from the loudspeaker 1316 to the surroundings of the cellular telephone 1300.

Both the earpiece speaker 1312 and the loudspeaker 1316 are coupled to a common acoustic resonator 1436. The common acoustic resonator 1436 comprises an upper space 1438 located between the upper outer housing part 1304, and the speaker holder 1308, and a lower space 1440 located between the inner housing 1306, and the speaker holder 1308. The upper space 1438 is encompassed by an upper peripheral gasket 1322 which seals between the upper perimeter of the speaker holder 1308, and the upper outer housing part 1304. The upper space 1438 excludes the space encompassed by the first circular gasket 1321. Similarly, the lower space 1436 is encompassed by a lower peripheral gasket 1442 that seals between the lower perimeter of the speaker holder 1308 and the inner housing 1306. The lower space 1436 excludes the space encompassed by the second circular gasket 1430.

The common acoustic resonator 1436 further comprises three irregularly shaped holes 1444 through the speaker holder 1308. The irregularly shaped holes 1444 coupled the upper 1438 and lower 1440 spaces, and also serve to beneficially increase the volume of the acoustic resonator 1436, and thereby increase the response of the speakers 1312, 1316 at low frequencies. The shape of the holes 1444 allows them to fit within the limited available space in the speaker holder 1308.

If a cancellation filter, were not used in driving the earpiece speaker 1312, when the loudspeaker 1316 is driven, then acoustic energy generated by the loudspeaker 1316, and coupled through the common acoustic resonator 1436 to the earpiece speaker 1312, could be further coupled through the earpiece speaker 1312 at undesirably high levels and reach a user's ear. However by using a cancellation filter in driving the earpiece speaker 1312 with a cancellation filtered version of the loudspeaker drive signal, the amount of acoustic energy coupled from the loudspeaker 1316 through the common acoustic resonator 1436 and in turn the earpiece speaker 1312 to the user's ear is reduced.

In the present embodiment the cancellation filter serves to convert the loudspeaker signal to a signal for the earpiece speaker 1312 that generates an electromotive force in the earpiece speaker 1312 that opposes the force of acoustic waves generated by the loudspeaker 1316 within the common resonator 1436 that act on the earpiece speaker diaphragm 1318 from within the common acoustic resonator 1436. In the present embodiment, the frequency response of the cancellation filter can be determined at each frequency by experimentally determining the phase, an amplitude of a signal applied to the earpiece speaker 1312 that minimizes the movement of the earpiece speaker diaphragm 1318 when driving the loudspeaker with a reference signal of a predetermined phase and amplitude. The needed complex response of the cancellation filter at each frequency is then simply the quotient of the reference signal divided by the experimentally determined signal. The motion of the earpiece speaker diaphragm 1318 can be measured with a laser Doppler vibrometer. When the force of acoustic waves emanating from the loudspeaker 1316 and acting on the earpiece speaker diaphragm 1318 are well matched in amplitude and phase by an electromotive force due to the cancellation filtered signal applied to the earpiece speaker 1312, the movement of the earpiece speaker diaphragm 1318 will be substantially reduced, and the achieved cancellation will be largely independent of the earpiece speaker 1312 loading conditions.

On the other hand if in a particular embodiment the common resonator shared by the two speaker 1312, 1318 is such that the coupling coefficient is high (at a particular frequency or over a broad range of frequencies), and/or if the power handling capacity of the earpiece speaker 1312 is limited such that the force of acoustic energy emanating from the loudspeaker 1316 and acting on the earpiece speaker diaphragm 1318 can not be completely nulled by a cancellation filtered signal applied to the earpiece speaker 1312, then the earpiece diaphragm 1318 will move, and its movement may depend on the acoustic loading conditions of the earpiece speaker 1312. In the latter case, the optimum complex frequency response of the cancellation filter for minimizing the coupling of acoustic energy from the loudspeaker 1316 through the earpiece speaker 1312 can be determined under the three loading conditions discussed above using ear simulators, and an average of the complex frequency responses obtained in the three load conditions used in implementing a cancellation filter. A weighted average may be used to give more consideration to the coupling conditions, i.e. low, and high leakage, which are more likely to obtain in real world use. The complex frequency response (e.g., real and imaginary part or equivalently phase and amplitude) of the cancellation filter can be determined by routine experimentation.

FIG. 15 is a block diagram of an audio system of the cellular telephones shown in FIGS. 1-3, 14-15. As shown in FIG. 15 a signal source is coupled through a delay 1504 to the loudspeaker 1316, 238, and the signal source 1502 is also coupled through a cancellation filter 1506 to the earpiece speaker 1312, 234. The signal source 1502, the delay 1504, and the cancellation filter 1506 can be implemented as a programmed, programmable processor, or as dedicated digital and/or analog hardware circuits.

While the preferred and other embodiments of the invention have been illustrated and described, it will be clear that the invention is not so limited. Numerous modifications, changes, variations, substitutions, and equivalents will occur to those of ordinary skill in the art without departing from the spirit and scope of the present invention as defined by the following claims.

1. A portable communication device comprising:
an earpiece speaker,
a loudspeaker,
a circuit coupled to the earpiece speaker, and the loudspeaker, said circuit comprising:
a signal source for generating a signal for driving the loudspeaker, wherein said signal source is coupled to the loudspeaker; and
a cancellation filter, wherein said signal source is further coupled to the earpiece speaker through a cancellation filter.

2. The portable communication device according to claim 1 further comprising:
a common acoustic resonator coupled to the earpiece speaker, and to the loudspeaker.

3. The portable communication device according to claim 1 wherein:
the cancellation filter comprises a digital filter.

4. The portable communication device according to claim 3 wherein:
the circuit comprises, a processor;
the signal source comprises a software implemented signal source; and
the cancellation filter comprises a software implemented digital filter.

5. A portable communication device comprising:
an earpiece speaker;
a loudspeaker;
an acoustic resonator acoustically coupled to the earpiece speaker and the loudspeaker;
a first amplifier drivingly coupled to the earpiece speaker;
a second amplifier drivingly coupled to the loudspeaker;
a first digital to analog converter drivingly coupled to the first amplifier;
a second digital to analog converter drivingly coupled to the second amplifier;
a processor coupled to the first digital to analog converter, and coupled to the second digital to analog converter wherein the processor is programmed to:
apply a loudspeaker drive signal to the second digital to analog converter;
apply a cancellation filter to the drive signal to obtained a cancellation filtered drive signal; and
apply the cancellation filtered drive signal to the first analog to digital converter.

6. The portable communication device according to claim 5 wherein:
in applying the cancellation filter to the drive signal, the processor is programmed to apply a finite impulse response filter to the drive signal.

7. The portable communication device according to claim 5 wherein:
the acoustic resonator comprises an opening for coupling acoustic energy from the earpiece speaker to a user's ear.

8. A method of operating a portable communication device, the method comprising:
applying a drive signal to a loudspeaker of the portable communication device:
cancellation filtering the drive signal with a cancellation filter to obtained a cancellation filtered drive signal;
driving an earpiece speaker of the portable communication device with the cancellation filtered drive signal;
whereby, a level of sound emanating from the loudspeaker, and coupled to a user's ear is reduced.

9. The method according to claim 8 further comprising:
prior to applying the drive signal to the loudspeaker, delaying the drive signal.

10. The method according to claim 8 wherein:
cancellation filtering comprises, filtering with a cancellation filter that is characterized by a first frequency response that, when compounded with a second frequency response that characterizes electrical to acoustic transducing response of the earpiece speaker, substantially negates a third frequency response that characterizes electrical to acoustic transducing response of the loudspeaker as measured with an ear simulator.

11. The method according to claim 10 wherein:
cancellation filtering comprises digitally filtering with a finite impulse response filter.
